(19) United States
(12) Patent Application Publication
(10) Pub. No.: US 2025/0078382 A1
(43) Pub. Date: Mar. 6, 2025

(54) RECORDING 3D IMAGE DATA USING A LIGHT SECTIONING PROCESS

(71) Applicant: SICK AG, Waldkirch (DE)

(72) Inventors: Denise BERTZ, Waldkirch (DE); Katharina BLEICHER, Waldkirch (DE); Siegfried RINGWALD, Waldkirch (DE); Jens EDHAMMER, Waldkirch (DE); Anders MURHED, Waldkirch (DE)

(21) Appl. No.: 18/819,858

(22) Filed: Aug. 29, 2024

(30) Foreign Application Priority Data
Aug. 30, 2023 (EP) 23194139.4

(51) Int. Cl. G06T 15/00; G02B 13/10; G06V 10/141

(52) U.S. Cl. CPC G06T 15/00; G02B 13/10; G06V 10/141

(57) ABSTRACT

A camera for recording 3D image data using a light sectioning process is provided that has an illumination unit to project a light pattern in a focal plane, an image sensor having a plurality of light reception elements in an image plane, a reception optics upstream of the image sensor and having an objective plane, and a control and evaluation unit that is configured to generate the 3D image data by evaluating the light pattern in a recording of the image sensor, wherein the image plane is tilted with respect to the focal plane. In this respect, the reception optics has at least one metaelement here that compensates an oblique light incidence on the light reception elements.

The invention relates to a camera and to a method for recording 3D image data using a light sectioning process respectively.

In a light sectioning process, a light pattern is projected into the detection zone and a conclusion is drawn on the height profile from the distortion using a triangulation process. Laser triangulation using a linear light source is particularly widespread. In this respect, the detection typically takes place in a relative movement to combine the respective two-dimensional height profiles into 3D image data. In some cases, the level is additionally measured and a brightness image or a texture is thus detected.

FIG. 8 illustrates the known Scheimpflug arrangement in which a laser line can be recorded in focus over the total measurement range to acquire high quality 3D image data. In this respect, the camera 100 is set up with one objective 102 so that its image plane 104, the objective plane 106, and the focal plane 108 intersect one another in a common straight line. The light here, however, is obliquely incident on the image sensor of the camera 100 due to the Scheimpflug arrangement and the chief ray angle of the objective 102. The effect of the Scheimpflug arrangement affects all the pixels equally, whereas the chief ray angle has individual effects per pixel, is namely still at 0° with a central pixel and then increases toward the margins of the image sensor. The Scheimpflug arrangement thus reduces the light yield since all the light does not reach the respective pixel due to the oblique light incidence. In addition, cameras set up in a Scheimpflug arrangement are very large.

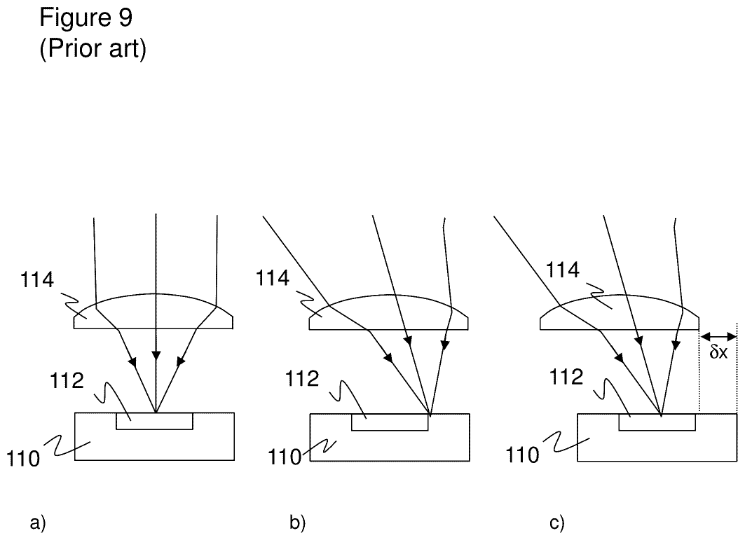

FIG. 9 illustrates a conventional solution for increasing the light sensitivity of an image sensor. Each of the FIGS. 9a-c shows an exemplary pixel 110 with its light sensitive surface 112 and an upstream microlens 114. With perpendicular light incidence as in FIG. 9a, the light is thereby bundled onto the light sensitive surface 112. With an oblique light incidence as in FIG. 9b, there is, however, a lateral displacement that results in a partial or full missing of the light sensitive surface 112. As compensation, the microlens 114 can, as in FIG. 114, be given an offset δx with respect to the light sensitive surface 112. However, the offset δx must be suitable for the angle of incidence for this purpose. This requires a very expensive special design that additionally has to be carried out respectively for every sensor variant. The light that misses the light sensitive surface 112 not only reduces the light sensitivity of the image sensor, but also generates scattered light that further degrades the image recording.

A further negative effect of the oblique light incidence is the multiple reflection in a glass cover. This does not occur with perpendicular light incidence; then there is only a harmless back reflection in the direction of the light surface that does not impact the image sensor. Anti-reflection coatings also demonstrate angular dependence.

Different use possibilities of wedge prisms are discussed in the paper Howard, James W.: “Formulas for the coma and astigmatism of wedge prisms used in converging light”, Applied optics 24.23 (1985): 4265-4268. They can inter alia be used to tilt the image plane or to correct its tilt. This effect is, however, always accompanied by aberrations. They may have either no coma or no astigmatism, but never prevent both. The use in laser triangulation, which is anyway not addressed in the paper, would therefore introduce additional measurement errors.

The paper by Reshef, Orad, et al. “An optic to replace space and its application towards ultra-thin imaging systems”, Nature communications 12.1 (2021): 1-8 looks at so-called metalenses and spaceplates without any connection to laser triangulation. Metalenses are extremely thin optical elements having a lens effect that have special nanostructures to influence beam paths. Spaceplates in turn are directed with similar technologies to the region between the lenses since a plurality of metalenses also first have to observe a distance from one another like classical lenses. The spaceplates should reduce this distance to be able to further reduce the construction depth of an optics. Nanoimprinting is a special method for generating such nanostructures.

DE 10 2021 119 423 A1 discloses a triangulation sensor that deploys an optical metaelement in its reception path to compensate different unfavorable triangulation effects. Such a triangulation sensor only measures in a scalar or one-dimensional manner and may not be confused with a camera of the category for recording 3D image data using a light sectioning process or laser triangulation. Camera-specific questions such as a Scheimpflug arrangement and optimization in both axes of an image sensor do not occur at all in DE 10 2021 119 423 A1. The displacement of the received light spot is specifically bounded by an optical metaelement in the near zone in DE 10 2021 122 418 A1.

A LARP (laser activated remote phosphor) device is presented in US 2019/0170314 A1. In this respect, a wedge prism, a metalens, and a Scheimpflug arrangement are named in different embodiments, but without putting them in any closer relationship with one another. The document has nothing to do with laser triangulation.

It is therefore the object of the invention to improve the detection of 3D image data by a light sectioning process.

This object is respectively satisfied by a camera and by a method for recording 3D image data using a light sectioning process. A light sectioning process generally means the detection of 3D image data from distortion of a projected light pattern by the object contours by means of triangulation and in particular laser triangulation in which a light line is projected as the light pattern. A light source, in particular a laser, projects the light pattern or the light line in a focal plane. An image sensor having a plurality of light reception elements or pixels, that are typically arranged to form a matrix, records the light pattern on the objects impinged thereby. A reception optics having an object plane is arranged upstream of the image sensor. A control and evaluation unit evaluates the recorded profile of the light pattern to determine the 3D image data. The image plane is tilted with respect to the focal plane.

The invention starts from the basic idea of providing at least one optical metaelement in the reception optics. An oblique light incidence on the light reception elements is thus compensated. The oblique light incidence in particular results, as discussed in the introduction, from the tilt between the image plane and the focal plane and/or a respective chief ray angle. The metaelement acts differently on the remitted light beam in dependence on the embodiment and/or replaces and/or supplements the reception optics. The metaelement for this purpose has a metasurface and/or a metalmaterial, i.e. nanostructures, that form certain wavefronts of the remitted light beam in a very targeted manner. With a metasurface, such nanostructures are provided at the surface; a metamaterial achieves corresponding properties through the nanostructure of a layer system or of a solid body.

The invention has the advantage that smaller angles of incidence can be implemented on the image sensor. This improves the light sensitivity and furthermore disruptive side effects of a Scheimpflug arrangement are alleviated, depending on the embodiment, or the advantages of a Scheimpflug arrangement are even achieved without an actual Scheimpflug arrangement, which in turn makes more compact construction shapes possible and simplifies the manufacture. The vertical resolution can be linearized in some embodiments. The optical metaelement facilitates the variant formation since only a different metaelement has to be used for different construction shapes or different focal planes or the metaelement is even adaptable to the different construction shape or can likewise satisfy its function in the different construction shape. The optical metaelement can perform the work of the reception optics with smaller lens errors or can compensate lens errors of an object still used in the reception optics. The multiple reflections in a glass cover mentioned in the introduction can be avoided thanks to the optical metaelement.

The metaelement preferably generates a prismatic effect. The angle of incidence of the incident received light is thereby changed before it is incident on the image sensor. An oblique light incidence on the image sensor thus becomes a perpendicular light incidence or an oblique angle of incidence is at least reduced in the direction of a perpendicular light incidence.

The metaelement preferably has a different optical effect over the light reception elements. An individual compensation per light reception element can be taken into account in the metaelement, but would not be implementable at all using classical means. It is conceivable to compensate in a manner that is the same within a respective group directly for groups of light reception elements such as rows or columns in the metaelement.

The reception optics preferably has a microlens array upstream of the image sensor. The effects of a microlens array for bundling received light on the light sensitive zones of the image sensor and of the optical metaelement provided in accordance with the invention can thereby be combined with one another.

The microlenses of the microlens array preferably have an offset with respect to the light reception elements. The offset conventionally serves to compensate the oblique light incidence, which the optical metaelement performs in accordance with the invention. A standard microlens array without offset can therefore be used and this has advantages with respect to the flexible options for use in different variants of the camera and with respect to the costs. These embodiments with a combination of the offset of the microlenses and the use of a metaelement nevertheless remain possible.

The metaelement preferably provides a perpendicular light incidence in the respective microlens. A full compensation of the oblique light incidence is thus even possible.

The metaelement preferably additionally has the function of a microlens field. In this embodiment, a microlens field can be dispensed with and a comparable optical effect of the bundling on the respective light sensitive zone of a light reception element can nevertheless be achieved. The metaelement itself provides a corresponding focusing on the light sensitive zones of the image sensor in addition to the compensation of the oblique light incidence.

In further conceivable combinations, the metaelement only partially replaces the function of the microlens field so that the microlens field and the metaelement complement one another. It is furthermore conceivable that two or more metaelements share the respective required optical functionality.

The reception optics preferably has a reception lens. There is therefore still a classical reception lens or a classical reception objective in such embodiments.

The image sensor is preferably tilted with respect to the reception lens in a Scheimpflug arrangement. The image plane, an objective plane of the reception lens, and the focal plane consequently intersect one another in a common straight line. The optical metaelement provides that the received light is respectively incident on the light reception elements as perpendicular as possible despite the tilts of the image sensor.

The image sensor and the reception lens are preferably arranged with respect to one another such that the image plane and the objective plane are in parallel. The Scheimpflug arrangement is here avoided as an alternative in a physical observation. The optical metaelement, however, emulates the advantageous optical effects of the Scheimpflug arrangement,

The metaelement is preferably configured to bundle light from the focal plane on the image sensor. In this respect, the optical metaelement preferably takes over the function of the reception lens alone or, alternatively, in combination with the reception lens or as part of a reception optics. As already mentioned, there can be a plurality of metaelements, for example one metaelement for the function of the reception lens and a further metaelement to compensate the oblique light incidence, or a single metaelement does both.

The metaelement is preferably an active metaelement. A metaelement is to be understood by this that is adaptable in its optical properties. An adaptation can thus take place for a specific focal plane or tilt and equally for specific cameras or recording situations. A plurality of metaelements thereby, for example, do not have to be manufactured for variants of the camera or for specific applications or variants of the camera can be dispensed with overall, at least to a certain extent, by an adaptation by means of an active metaelement

The reception optics preferably has a spaceplate. No German technical term has been developed for this yet. A spaceplate is likewise a metamaterial, but not primarily designed for a change of the wavefront corresponding to a tilt effect or lens effect. A longer optical path should rather so-to-say be implemented on a smaller physical space to be able to arrange optical elements, in particular metalenses, closer to one another. It is in particular conceivable to provide a front side and/or rear side of the spaceplate with a metasurface to combine the effects of a spaceplate with those of the optical metaelement. A spaceplate makes possible a particularly compact design in embodiments in which the optical metaelement also takes over a dual function as a reception lens. Reference is additionally made to the paper named in the introduction of Reshef et al. for further details on spaceplates.

The metaelement is preferably designed for a multifocal image recording. Different focal planes can thereby be detected as focused with different tilts. This is of interest for the detection of a plurality of region of interest (ROIs), in particular in the case of a plurality of laser lenses or on the use of lines of the image sensor for special purposes such as some marginal lines as color lines.

The metaelement preferably has anamorphic properties, that is different focal properties in the two axes of the image sensor. Additional lenses with corresponding construction space and costs would be required for this with classical optical means. The metaelement can also satisfy such demands if required.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

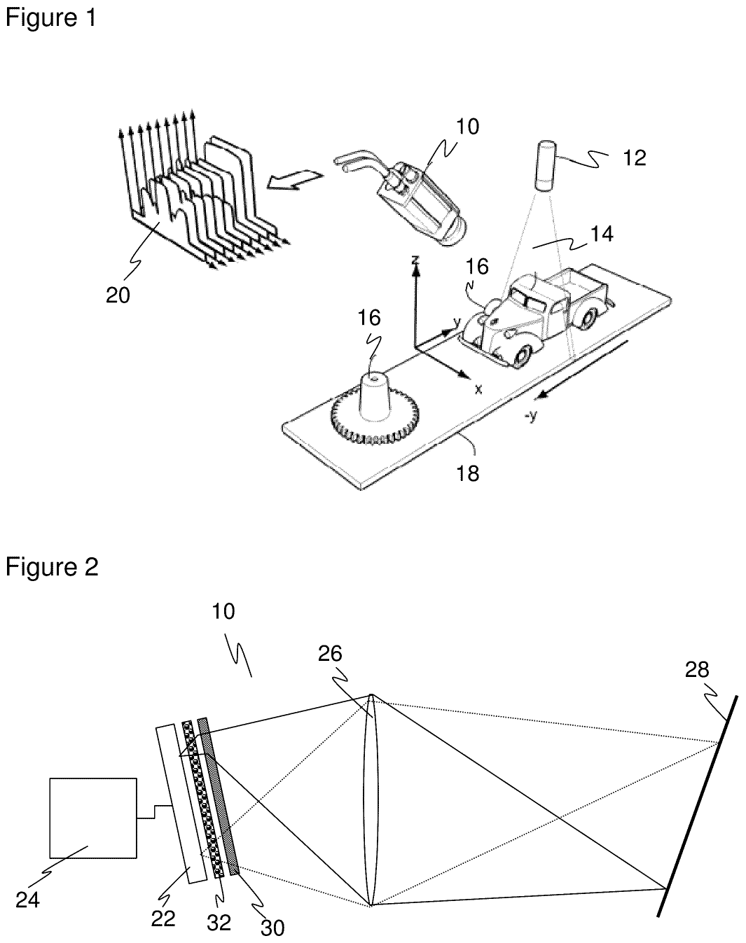

FIG. 1 an overview representation of a camera for 3D image recording in accordance with a light sectioning process or by means of laser triangulation and its detection zone;

FIG. 2 a schematic representation of an embodiment of the camera in a Scheimpflug arrangement to compensate the oblique light incidence by an optical metaelement.

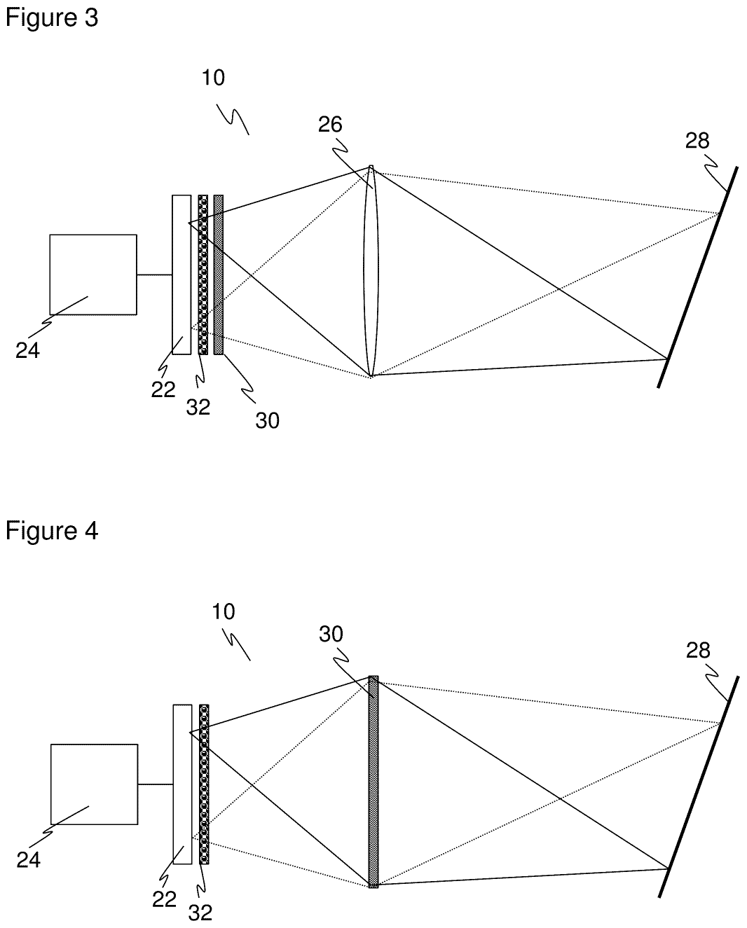

FIG. 3 a schematic representation of an embodiment of the camera without a physical Scheimpflug arrangement, but with a comparable optical effect by means of an optical metaelement;

FIG. 4 a schematic representation of an embodiment of the camera in which the optical metaelement additionally takes over the function of the reception lens;

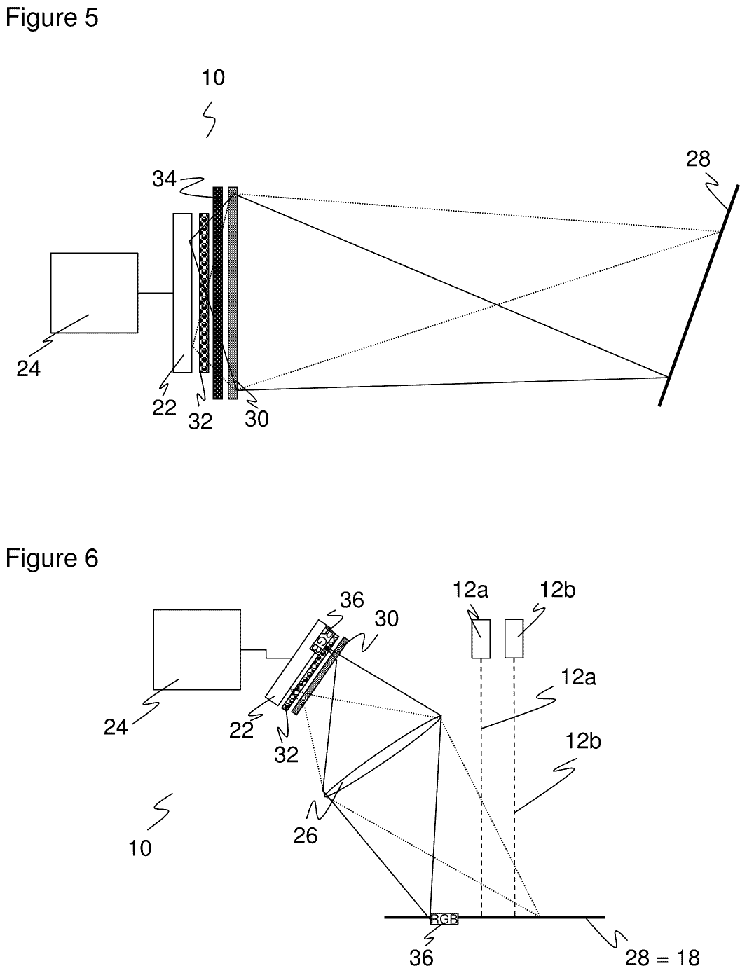

FIG. 5 a schematic representation of an embodiment of the camera with an additional spaceplate;

FIG. 6 a schematic representation of an embodiment of the camera with a plurality of projected illumination lines and reception zones;

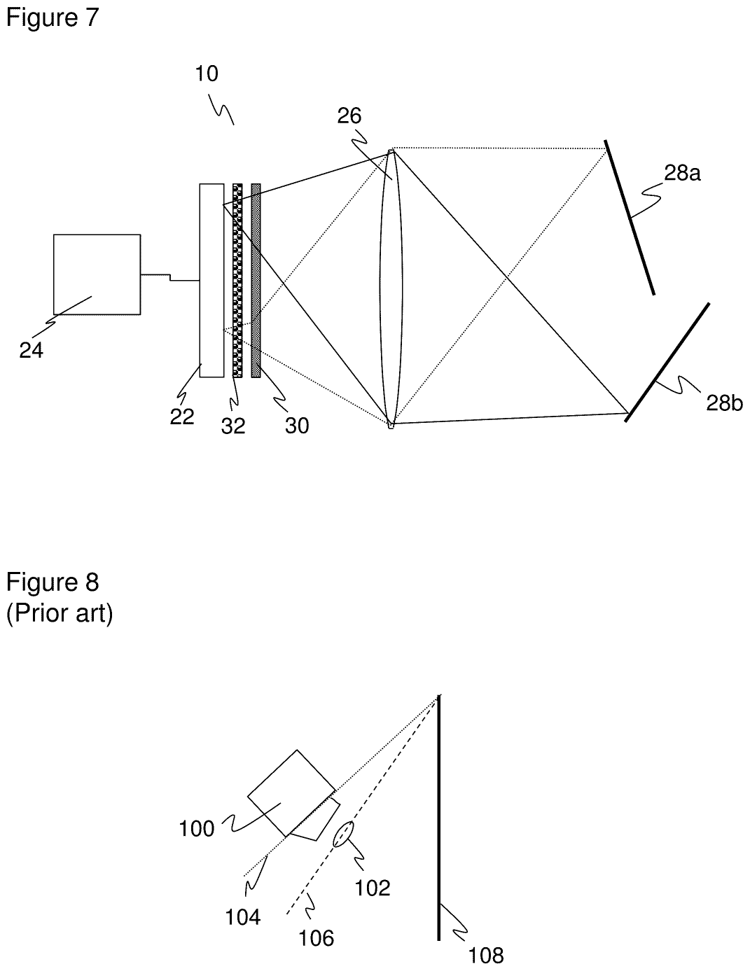

FIG. 7 a schematic representation of a multifocal embodiment of the camera;

FIG. 8 a schematic representation of the conventional Scheimpflug arrangement; and

FIG. 9 a schematic representation of the conventional use of microlenses, in particular offset microlenses, in front of an image sensor.

FIG. 1 shows an overview representation of a camera 10 for 3D image recording in accordance with a light sectioning process or by means of laser triangulation in an exemplary recording situation. The principle of laser triangulation is known per se and will therefore only be briefly presented. An illumination unit 12 generates a light fan 14 in a focal plane and thus ultimately projects a light line onto the object 16 to be detected. The three-dimensional contour of the object 16 distorts the light line. In a recording of the camera 10, the shape of the light line is evaluated to draw a conclusion on the three-dimensional contour with knowledge of the geometrical arrangement and properties of the camera 10 and illumination unit 12. Only a two-dimensional vertical profile corresponding to the object section below the light line is produced per recording in this process. The light line is gradually guided over the object 16 by means of a relative movement, for example of a conveyor belt 18. The 3D image data 20 then thereby result by a successive assembly of the two-dimensional vertical profiles.

FIG. 2 shows a schematic representation of an embodiment of the camera 10 in a Scheimpflug arrangement. For simplification, only the reception optics, still to be explained, an image sensor 22 with the light reception elements or pixels, not individually shown, and a control and evaluation unit 24 in which the triangulation evaluation takes place are shown of the camera 10. The control and evaluation unit 24 can be an internal processing unit, an external processing unit or a combination of the two. Examples for an internal processing unit are digital processing modules such as a microprocessor or a CPU (central processing unit), an FPGA (field programmable gate array), a DSP (digital signal processor), an ASIC (application specific integrated circuit), an Al processor, an NPU (neural processing unit), a GPU (graphics processing unit) or the like. An external processing unit can be a controller or a computer of any desired kind, including notebooks, smartphones, tablets, equally a local network, an edge device, or a cloud.

The camera 10 is set up in a Scheimpflug arrangement in this embodiment. A single reception lens 26 is drawn as representative of the reception objective.

Scheimpflug arrangement means, as already explained with reference to FIG. 8 in the introduction, that the image plane of the image sensor 22, the objective plane of the reception lens 26, and the focal plane 28 intersect one another in a common straight line. The focal plane 28 is tilted toward the image plane as a required, insufficient condition for this.

To compensate the oblique light incidence on the image sensor 22, an optical metaelement 30 upstream of the image sensor 22 is provided. A microlens field 32 can optionally additionally be used, preferably between the optical metaelement 30 and the image sensor 22. The microlenses can be a standard component with centered microlenses as in FIG. 9a or can be equipped with an offset as in FIG. 9c, with the latter no longer being required due to the optical metaelement 30, but nevertheless being possible, for example in that the offset and the optical metaelement 30 share the required angle compensation between them.

The optical metaelement 30 has a metamaterial or a metasurface, the latter preferably produced by nanoimprinting. Conventional optical components such as lenses, prisms, waveplates, or holograms are based on light propagation over distances that are much larger than the wavelength of the light fan 14 to form wavefronts. In this way, substantial changes of the amplitude, phase, or polarization of light waves are gradually accumulated along the optical path. The optical metaelement 30 in contrast has structures that can be imitated as miniature anisotropic light scatterers or resonators or optical antennas. These structures have dimensions and distances in the nanometer range, much smaller than the wavelength of the light fan 14. The optical metaelement 30 thereby shapes in accordance with the Huygens principle optical wavefronts into any desired forms having sub-wavelength resolution in that the nanostructures introduce spatial variations in the optical response of the light scatterers. Optical effects, in particular also of lenses or prisms, can thus be understood. A special feature is the high flexibility of reaching a desired starting wavefront and thus the most varied optical effects through adapted nanostructures. Depending on the wavelength range, materials having a suitable transmission behavior are used, for example titanium dioxide, silicon nitride, or gallium phosphide in the visible spectral range and aluminum nitride in the ultraviolet spectral range, and chalcogenide alloys in the medium wave and silicon in the long wave infrared range.

A compensation of an angle of incidence of the received light on the image sensor 22, in particular individually per light reception element, is expected in the camera 10 by the optical metaelement 30. This is comparable with the effect of wedge prisms, but this effect is achievable without aberrations in a metamaterial. The simulated wedge prisms can set a separate deflection angle per individual light reception element and thus provide a perpendicular light incidence on the light reception element. In this respect, the oblique light incidence due to the Scheimpflug arrangement and/or a chief ray angle can be compensated dependent on the location on the image sensor. The required nanostructure can be calculated and generated with the requirement of this specific optical effect. Such a compensation in the structural size of individual pixels would be impossible with classical optical elements. The optical metaelement 30 can additionally be simply replaced to model a different camera variant or application situation. The required optical effects can be implemented in a single optical metaelement 30, as shown, or can alternatively be spread over two or more optical metaelements.

FIG. 3 shows a schematic representation of an embodiment of the camera 10 without a physical Scheimpflug arrangement, but with a comparable optical effect by means of an optical metaelement 30. The optical effect of the Scheimpflug arrangement is a variation of the image distance, i.e. of the distance between the main plane on the image side and the image sensor 22 over its light reception elements. This swerves to compensate the effects of an oblique object plane and thus a varying object width. A focused recording with a varying object distance can also be achieved by a changed focal position over the image sensor 22 instead of by the physical Scheimpflug arrangement. The optical metaelement 30 is correspondingly mapped in this embodiment. It generates a focal position per light reception element that corresponds to a physical oblique position of the image sensor 22 in a Scheimpflug arrangement. A variation of the focal position by the optical metaelement 30 is individually possible per light reception element, but is preferably carried out only over the vertical direction, i.e. the same direction in which the focal plane 28 is also tilted with respect to the image plane of the image sensor 22. This can be called an emulated Scheimpflug arrangement by means of the optical metaelement 30. It is additionally conceivable to compensate the chief ray angle per light reception element in the optical metaelement 30, corresponding to the optical effect of offset microlenses. In this respect, reference is made to the explanations on the embodiment in accordance with FIG. 2. The functions of an emulated Scheimpflug arrangement and a compensation of the chief ray angle can be spread over two or more optical metaelements or can be implemented in a single optical metaelement 30.

FIG. 4 shows a schematic representation of a further embodiment of the camera 10. Unlike FIG. 3, the optical metaelement 30 here additionally takes over the function of the reception lens 26 or of the reception objective and is accordingly arranged at a greater distance from the image sensor 22 approximately in the position of the replaced reception lens 26. The optical metaelement 30 therefore has additional focusing properties as a metalens, like the replaced reception lens 26. The function of an emulated Scheimpflug arrangement described with respect to FIG. 3, in particular in combination with a compensation of the chief ray angle, is superposed on this focusing. The different optical functions can again be implemented in a single optical metaelement 30 or can be spread over at least two optical metaelements, here in particular with a position of a further optical metaelement close to the image sensor 22. As an additional optical function of the same optical metaelement 30 or of a further optical metaelement, the vertical resolution can be linearized, as has been described in the documents cited in the introduction DE 10 2021 119 423 A1 and DE 10 2021 122 418 A1, but now transferred from the conventional one-dimensional sensor to the camera 10.

FIG. 5 shows a schematic representation of an embodiment of the camera 10. In FIG. 4, the optical metaelement 30 that replaces the reception element 26 has to be arranged at a distance from the image sensor 22. A spaceplate is now added for a more compact design. As already briefly mentioned in the introduction, a spaceplate 34 is a special optical metaelement that may replace a longer light path through the air in very tight space. Thanks to the spaceplate 34, it is accordingly again possible to arrange the optical metaelement 30 very close to the image sensor 22. The total reception optics can thus be implemented in a minimal construction depth as a kind of sandwich of the image sensor 22, optional microlens field 32, spaceplate 34, and optical metaelement 30, in particular in a monolithic design. A spaceplate can also be used in the other embodiments, but does not achieve the same compactness there due to the further present classical reception lens 26.

FIG. 6 shows a schematic representation of an embodiment of the camera 10 in an arrangement that can be called a reverse Scheimpflug arrangement. This is in particular suitable for the case of a plurality of recording zones, in the example shown, there are two laser lines of two illumination units 12a-b and RGB zones 36. The two laser lines are preferably offset from one another in a conveying direction to allow multiple measurements. The focal plane in this case is not the plane of the anyway no longer unambiguous light fan 14a-b, but rather a base plane of the objects such as a the surface of the conveyor belt 18. The arrangement shown is above all suitable for flat objects, for instance when inspecting wood.

FIG. 7 shows a schematic representation of a multifocal embodiment of the camera 10. It is based on the embodiment explained with respect to FIG. 3 and can be transferred to the other embodiments. The optical metaelement 30 supports a plurality of focal positions so that a plurality of regions of interest can be detected with different triangulation parameters or focal planes 28a-b. A line-wise color recording is thus made possible, for example, in addition to the laser triangulation. The reverse Scheimpflug arrangement in accordance with FIG. 6 can thus also be used for different object distances or object heights and not only for flat objects.

It is conceivable as a further variant without its own Figure to provide the reception optics with anamorphic properties via the optical metaelement 30, that is different focusing properties in the two axes of the image sensor 22. This is in particular suitable for the embodiment in accordance with FIG. 4. An image can be compressed or stretched in width at the same height via anamorphic properties, for example. This would only be possible with classical lenses with a very high effort by further lenses and by the additional construction space required for this.

1. A camera for recording 3D image data using a light sectioning process that has an illumination unit to project a light pattern in a focal plane, an image sensor having a plurality of light reception elements in an image plane, a reception optics arranged upstream of the image sensor and having an objective plane, and a control and evaluation unit that is configured to generate the 3D image data by evaluating the light pattern in a recording of the image sensor, wherein the image plane is tilted with respect to the focal plane, and
wherein the reception optics has at least one metaelement that compensates an oblique light incidence on the light reception elements.

2. The camera in accordance with claim 1,
wherein the metaelement generates a prismatic effect.

3. The camera in accordance with claim 1,
wherein the metaelement has a different optical effect over the light reception elements.

4. The camera in accordance with claim 1,
wherein the reception optics has a microlens array upstream of the image sensor.

5. A camera in accordance with claim 4,
wherein the microlenses of the microlens array have an offset with respect to the light reception elements.

6. The camera in accordance with claim 4,
wherein the metaelement provides a perpendicular light incidence in the respective microlens.

7. The camera in accordance with claim 1,
wherein the metaelement additionally has the function of a microlens field.

8. The camera in accordance with claim 1,
wherein the reception optics has a reception lens.

9. The camera in accordance with claim 8,
wherein the image sensor is tilted with respect to the reception lens in a Scheimpflug arrangement.

10. The camera in accordance with claim 8,
wherein the image sensor and the reception lens are arranged with respect to one another such that the image plane and the objective plane are in parallel.

11. The camera in accordance with claim 1,
wherein the metaelement is configured to bundle light from the focal plane on the image sensor.

12. The camera in accordance with claim 1,
wherein the metaelement is an active metaelement that is adaptable in its optical properties.

13. The camera in accordance with claim 1,
wherein the reception optics has a spaceplate.

14. The camera in accordance with claim 1,
wherein the metaelement is configured for a multifocal image recording;
and/or wherein the metaelement has anamorphic properties.

15. A method of recording 3D image data in accordance with the principle of the light sectioning process, in which a light pattern is projected in a focal plane, an image sensor having a plurality of light reception elements in an image plane records the light pattern by a reception optics arranged upstream of the image sensor and having an objective plane, and the recorded light pattern is evaluated to generate the 3D image data, wherein the image plane is tilted with respect to the focal plane, and wherein the reception optics has at least one metaelement that compensates an oblique light incidence on the light reception elements.
